(19) United States
(12) Patent Application Publication
(10) Pub. No.: US 2023/0406352 A1
(43) Pub. Date: Dec. 21, 2023

(54) DEPENDENCY MODELING FOR AUTONOMOUS VEHICLES

(71) Applicant: GM Cruise Holdings LLC, San Francisco, CA (US)

(72) Inventor: Burkay Donderici, Burlingame, CA (US)

(73) Assignee: GM Cruise Holdings LLC, San Francisco, CA (US)

(21) Appl. No.: 17/843,811

(22) Filed: Jun. 17, 2022

(51) Int. Cl. B60W 60/00; G01C 21/34

(52) U.S. Cl. CPC B60W 60/0015; G01C 21/3438; B60W 2420/42; B60W 2420/52

(57) ABSTRACT

A computing apparatus, comprising: a processor circuit and a memory; and instructions encoded within the memory to instruct the processor to: receive a stored dependency graph for a first hardware configuration for a plurality of compute nodes; receive a second hardware configuration comprising a modification to the first hardware configuration; iteratively model the second hardware configuration comprising adjusting one or more of a plurality of operational parameters for a model of the second hardware configuration, and selecting an optimum configuration of the plurality of operational parameters; and sending the optimum configuration to a real-world embodiment of the second hardware configuration.

### FIELD OF THE SPECIFICATION

The present disclosure relates generally to autonomous vehicle (AV) operation, and more particularly, though not exclusively, to a system and method for dependency modeling for autonomous vehicles (AVs).

### BACKGROUND

AVs, also known as self-driving cars, driverless vehicles, and robotic vehicles, are vehicles that use multiple sensors to sense the environment and move without human input. Automation technology in the AVs enables the vehicles to drive on roadways and to perceive the vehicle's environment accurately and quickly, including obstacles, signs, and traffic lights. The vehicles can be used to pick up passengers and drive the passengers to selected destinations. The vehicles can also be used to pick up packages and/or other goods and deliver the packages and/or goods to selected destinations.

### SUMMARY

A computing apparatus, comprising: a processor circuit and a memory; and instructions encoded within the memory to instruct the processor to: receive a stored dependency graph for a first hardware configuration for a plurality of compute nodes; receive a second hardware configuration comprising a modification to the first hardware configuration; iteratively model the second hardware configuration comprising adjusting one or more of a plurality of operational parameters for a model of the second hardware configuration, and selecting an optimum configuration of the plurality of operational parameters; and sending the optimum configuration to a real-world embodiment of the second hardware configuration.

### BRIEF DESCRIPTION OF THE DRAWINGS

The present disclosure is best understood from the following detailed description when read with the accompanying FIGURES. In accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram 100 illustrating an example AV.

FIG. 2 is a block diagram of selected elements of an AV controller.

FIG. 3 is a block diagram illustration of resource utilization.

FIG. 4 is a block diagram of selected elements of a global optimizer.

FIG. 5 is a flowchart of a method of optimizing an AV controller hardware configuration.

FIG. 6 is a block diagram of a hardware platform.

FIG. 7 is a block diagram of a Network Function Virtualization (NFV) infrastructure.

FIG. 8 is a block diagram of selected elements of a containerization infrastructure.

FIG. 9 illustrates machine learning according to an exemplary problem with real-world applications.

FIG. 10 is a flowchart of a method.

FIG. 11 is a flowchart of a method.

FIG. 12 is a block diagram illustrating selected elements of an analyzer engine.

### DETAILED DESCRIPTION

Overview

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

An AV controller for a production AV may be designed and optimized for a specific hardware configuration. The term “optimized” or “optimization,” as used throughout the specification and the appended claims, should be understood to not require a true theoretical optimization, or in other words, a true theoretical best possible state. Rather, the optimization of the present specification represents a best available or preferred configuration that is selected to provide good and acceptable performance for the AV controller. Thus, when an AV controller is optimized within the meaning of the present specification, there may exist a theoretically better configuration for the AV controller. But this theoretically better configuration may be difficult to identify and thus may not be practical. Thus, optimization, as used herein, may refer generally to the so-called Pareto optimization in which it is commonly understood that perfect optimization is the enemy of sufficient optimization. According to the Pareto criterion, an optimization that is within approximately 20 percent of the true optimum configuration is sufficient to provide acceptable performance. Once a sufficient optimization is achieved, seeking ever-increasing levels of theoretical optimization may present a problem of diminishing returns.

Thus, within the meaning of optimization as described above, the present specification provides a system and method wherein a global optimizer may optimize a hardware configuration for an AV controller. The AV ecosystem may be designed and optimized for a particular hardware configuration. It may be costly to maintain support for multiple sensor systems and hardware configurations. However, hardware and software modules may at times age out, receive upgrades, or otherwise be replaced in ways that disrupt the carefully configured optimization of the AV controller hardware. The AV controller hardware may include a number of compute nodes, each of which may perform a discrete computing task. These compute nodes may compete with one another for available resources and may also have data dependencies. For example, a planning node may require data from a perception node. The perception node may, in its turn, require data from a data collection node that receives raw data from the various sensors of the AV.

If operations in the various nodes were serialized, then the AV controller may realize relatively low resource utilization. The controller may also realize slow response times and significant lag. Thus, rather than serializing the various compute nodes of the AV controller, the nodes may operate in parallel. For example, the planning node may have a data dependency on perceptions from the perception node. In performing its computations, the planning node may not be required to wait for the perception node to finish a cycle of perceptions, but rather may retrieve the latest and best available perceptions from a perception data store. The planning node may then perform its function, such as executing a deep learning (DL) model on the latest available perception data. Similarly, the perception node may have a data dependency on the data collection node. The perception node may not wait for the data collection node to complete a cycle or a series of data collections, but rather may simply operate on the latest and best available collected sensor data available.

In addition to data dependencies, the various nodes may also have shared resource dependencies. For example, the perception node and planning node may both execute a DL model, which may execute on a graphics processing unit (GPU) within the system. Other nodes may use the GPU for other tasks, such as driving a user display, running other models, or performing other computations. Thus, an optimization for a particular hardware configuration may take into account a dependency graph that provides both the data and resource dependencies for a particular node and that allocates resources and data access in a way designed to realize optimal efficiency.

When a hardware or software module is replaced, such as with an upgrade or when a newer version becomes available, or because the existing version becomes unavailable, the previously computed optimizations may no longer be valid. Thus, the present specification provides a global optimizer that acts as a smart configuration system to maintain a graft of compute, functional, and runtime performance estimators and profilers. The global optimizer determines multiple computer assignment options and tests each one iteratively for functional and runtime feasibility. The system can make modifications to existing assignments to improve the functional and runtime (e.g., Pareto) performance. These modifications can be made by a global optimization system (genetic, reinforcement learning, or similar).

In some embodiments, the system may introduce, configure, and/or reconfigure DL optimizations as part of its modifications. For non-DL compute, a compiler may be used to produce binaries that are optimal for the current resource assignments. Automatic reconfiguration can be run dynamically as the AV software is modified, such as in a global optimization platform. Alternatively, optimization may be run onboard the AV controller when modifications occur.

The teachings of the present specification provide the ability to automatically and dynamically configure AV software resource assignments, optimizations, and other configurations on new or modified hardware and/or software environments. The smart reconfiguration system may maintain a dependency graph of the compute as well as functional and runtime performance estimators. The smart reconfiguration system may determine multiple resource assignments and optimization options, iterate through the various options, and optimize the global configuration by computing a cost function for each configuration. The smart reconfiguration system may also perform a beam search by modifying existing optimization options. Furthermore, the DL optimizations may be introduced and/or reconfigured as part of the search. A compiler may be used to produce binaries that are optimal for current resource assignments.

The foregoing can be used to build or embody several example implementations, according to the teachings of the present specification. Some example implementations are included here as nonlimiting illustrations of these teachings.

### DETAILED DESCRIPTION OF THE DRAWINGS

A system and method for dependency modeling for AVs will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

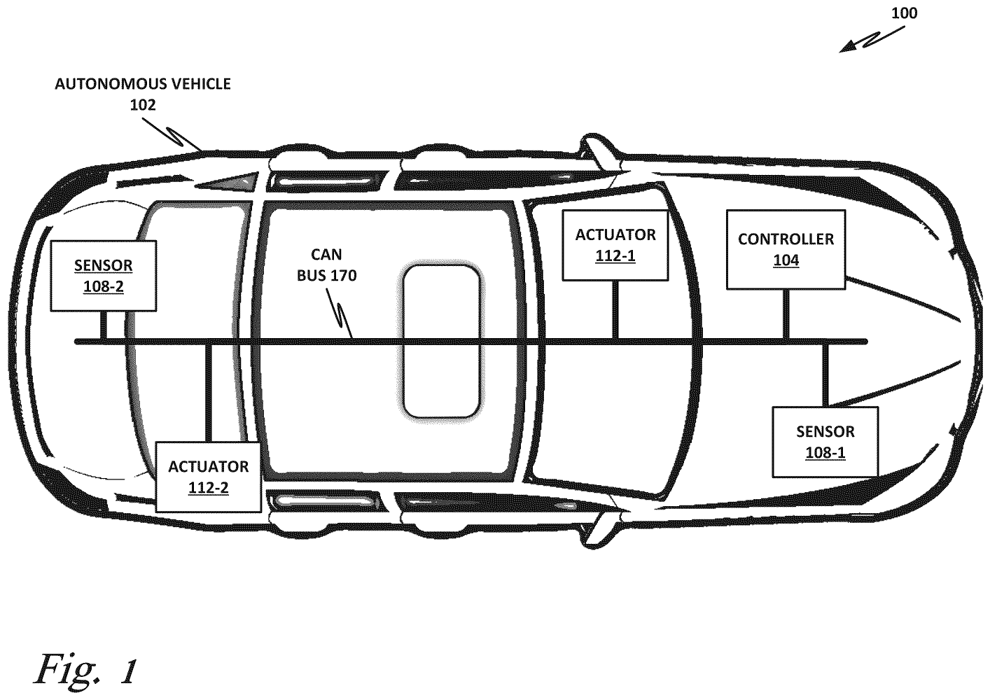

FIG. 1 is a block diagram 100 illustrating an example AV 102. AV 102 may be, for example, an automobile, car, truck, bus, train, tram, funicular, lift, or similar. AV 102 could also be an autonomous aircraft (fixed wing, rotary, or tiltrotor), ship, watercraft, hover craft, hydrofoil, buggy, cart, golf cart, recreational vehicle, motorcycle, off-road vehicle, three- or four-wheel all-terrain vehicle, or any other vehicle. Except to the extent specifically enumerated in the appended claims, the present specification is not Intended to be limited to a particular vehicle or vehicle configuration.

In this example, AV 102 includes one or more sensors, such as sensor 108-1 and sensor 108-2. Sensors 108 may include, by way of illustrative and nonlimiting example, localization and driving sensors such as photodetectors, cameras, Radio Detection and Ranging (RADAR), Sound Navigation and Ranging (SONAR), Light Detection and Ranging (LIDAR), GPS, inertial measurement units (IMUs), synchros, accelerometers, microphones, strain gauges, pressure monitors, barometers, thermometers, altimeters, wheel speed sensors, computer vision systems, biometric sensors for operators and/or passengers, or other sensors. In some embodiments, sensors 108 may include cameras implemented using high-resolution imagers with fixed mounting and field of view. In further examples, sensors 108 may include LIDARs implemented using scanning LIDARs. Scanning LIDARs have a dynamically configurable field of view that provides a point-cloud of the region intended to scan. In still further examples, sensors 108 includes RADARs implemented using scanning RADARs with dynamically configurable field of view.

AV 102 may further include one or more actuators 112. Actuators 112 may be configured to receive signals and to carry out control functions on AV 102. Actuators may include switches, relays, or mechanical, electrical, pneumatic, hydraulic, or other devices that control the vehicle. In various embodiments, actuators 112 may include steering actuators that control the direction of AV 102, such as by turning a steering wheel, or controlling control surfaces on an air or watercraft. Actuators 112 may further control motor functions, such as an engine throttle, thrust vectors, or others. Actuators 112 may also include controllers for speed, such as an accelerator. Actuators 112 may further operate brakes, or braking surfaces. Actuators 112 may further control headlights, indicators, warnings, a car horn, cameras, or other systems or subsystems that affect the operation of AV 102.

A controller 104 may provide the main control logic for AV 102. Controller 104 is illustrated here as a single logical unit and may be implemented as a single device such as an electronic control module (ECM) or other. In various embodiments, one or more functions of controller 104 may be distributed across various physical devices, such as multiple ECMs, one or more hardware accelerators, artificial intelligence (AI) circuits, or other.

Controller 104 may be configured to receive from one or more sensors 108 data to indicate the status or condition of AV 102, as well as the status or condition of certain ambient factors, such as traffic, pedestrians, traffic signs, signal lights, weather conditions, road conditions, or others. Based on these inputs, controller 104 may determine adjustments to be made to actuators 112. Controller 104 may determine adjustments based on heuristics, lookup tables, AI, pattern recognition, or other algorithms.

Various components of AV 102 may communicate with one another via a bus such as controller area network (CAN) bus 170. CAN bus 170 is provided as an illustrative embodiment, but other types of buses may be used, including wired, wireless, fiberoptic, infrared, WiFi, Bluetooth, dielectric waveguides, or other types of buses. Bus 170 may implement any suitable protocol. for example, in some cases bus 170 may use transmission control protocol (TCP) for connections that require error correction. In cases where the overhead of TCP is not preferred, bus 170 may use a one-directional protocol without error correction, such as user datagram protocol (UDP). Other protocols may also be used. Lower layers of bus 170 may be provided by protocols such as any of the family of institute of electrical and electronics engineers (IEEE) 802 family of communication protocols, including any version or subversion of 802.1 (higher layer local area network), 802.2 (logical link control), 802.3 (Ethernet), 802.4 (token bus), 802.5 (token ring), 802.6 (metropolitan area network), 802.7 (broadband coaxial), 802.8 (fiber optics), 802.9 (integrated service LAN), 802.10 (interoperable LAN security), 802.11 (wireless LAN), 80.12 (100VG), 802.14 (cable modems), 802.15 (wireless personal area network, including Bluetooth), 802.16 (broadband wireless access), or 802.17 (resilient packet ring) by way of illustrative and nonlimiting example. Non-IEEE and proprietary protocols may also be supported, such as for example, InfiniBand, FibreChannel, FibreChannel over Ethernet (FCoE), Omni-Path, Lightning bus, or others. Bus 170 may also enable controller 104, sensors 108, actuators 112, and other systems and subsystems of AV 102 to communicate with external hosts, such as internet-based hosts. In some cases, AV 102 may form a mesh or other cooperative network with other AVs, which may allow sharing of sensor data, control functions, processing ability, or other resources.

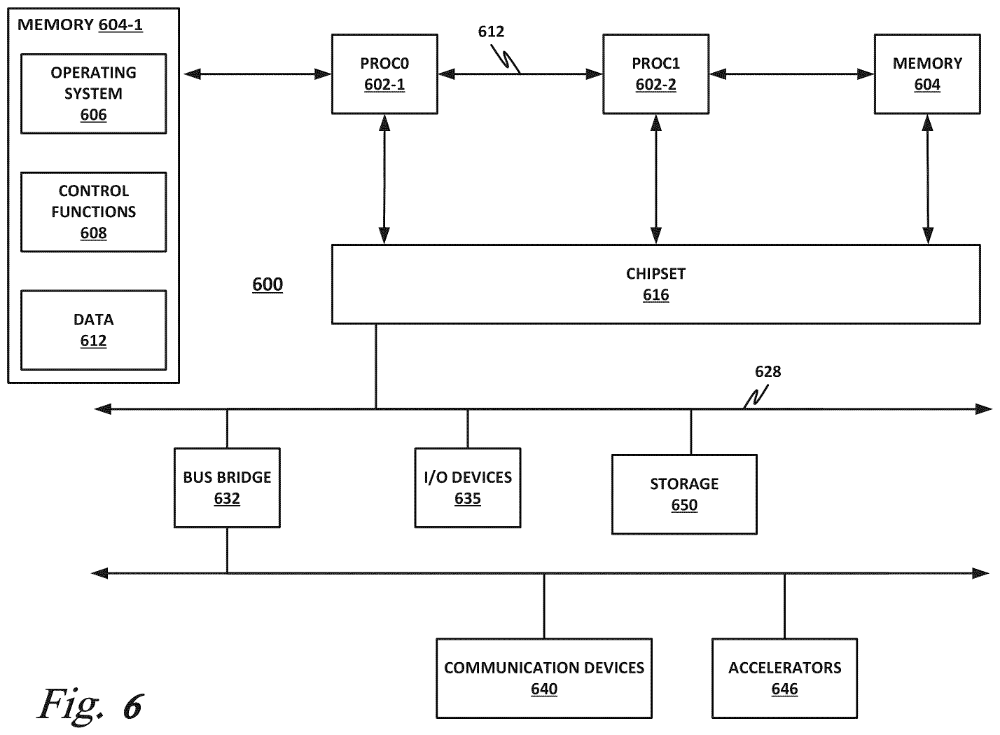

Controller 104 may control the operations and functionality of AVs 102, or one or more other AVs. Controller 104 may receive sensed data from sensors 108, and make onboard decisions based on the sensed data. In some cases, controller 104 may also offload some processing or decision making, such as to a cloud service or accelerator. In some cases, controller 104 is a general-purpose computer adapted for I/O communication with vehicle control systems and sensor systems. Controller 104 may be any suitable computing device. An illustration of a hardware platform is shown in FIG. 6, which may represent a suitable computing platform for controller 104. In some cases, controller 104 may be connected to the internet via a wireless connection (e.g., via a cellular data connection). In some examples, controller 104 is coupled to any number of wireless or wired communication systems. In some examples, controller 104 is coupled to one or more communication systems via a mesh network of devices, such as a mesh network formed by AVs.

According to various implementations, AV 102 may modify and/or set a driving behavior in response to parameters set by vehicle passengers (e.g., via a passenger interface) and/or other interested parties (e.g., via a vehicle coordinator or a remote expert interface). Driving behavior of an AV may be modified according to explicit input or feedback (e.g., a passenger specifying a maximum speed or a relative comfort level), implicit input or feedback (e.g., a passenger's heart rate), or any other suitable data or manner of communicating driving behavior preferences.

AV 102 is illustrated as a fully autonomous automobile but may additionally or alternatively be any semi-autonomous or fully autonomous vehicle. In some cases, AV 102 may switch between a semi-autonomous state and a fully autonomous state and thus, some AVs may have attributes of both a semi-autonomous vehicle and a fully autonomous vehicle depending on the state of the vehicle.

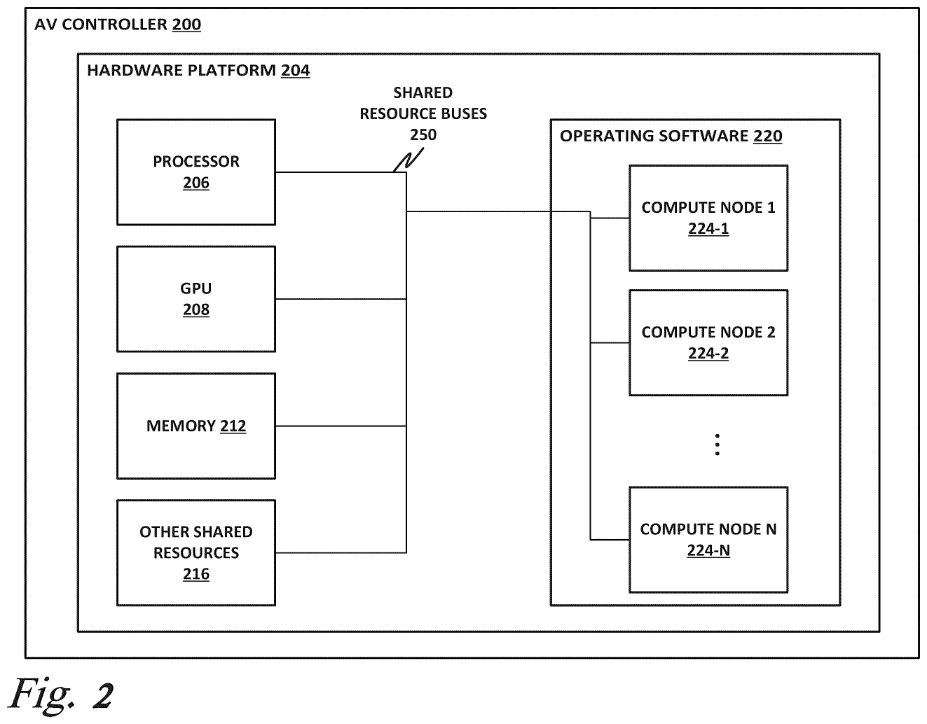

FIG. 2 is a block diagram of selected elements of an AV controller 200. AV controller 200 runs on a hardware platform 204. Additional details of a hardware platform are illustrated in FIG. 6 below, and the teachings of FIG. 6 should be considered equally applicable to FIG. 2.

Hardware platform 204 provides a processor 206. Processor 206 may, in a particular embodiment, be, for example, a digital signal processor (DSP) with certain hardware customizations that make it more efficient for use in an AV controller. Processor 206 could also be a general-purpose central processing units (CPUs) or other processor.

GPU 208 is also provided for various functions, including to run DL models and to drive user displays.

Memory 212 may include both volatile and nonvolatile memory and, in general, any of the classes or types of memory as illustrated throughout this specification.

Other shared resources 216 may also be provided to AV controller 200. These may include hardware and/or software resources, such as accelerators, application-specific integrated circuits (ASICs), field-programmable gate arrays (FPGA), software libraries, buses, or other resources that may be shared among various nodes and provide useful functions.

Hardware platform 204 provides one or more shared resource buses 250, which may be used to communicatively, electronically, and/or logically couple operating software 220 to available resources.

Operating software 220 may include a number of compute nodes, namely compute node 224-1, compute node 224-2, through compute node N 224-N. Compute nodes 224 may provide various discrete operations to support AV controller 200. In a typical AV controller 200, there may be as many as hundreds or thousands of compute nodes 224. These nodes may share the buses 250, processor 206, GPU 208, memory 212 or other shared resources 216. More specifically each node may allocate or reserve certain resource from the total available pool, and as a results may be in direct competition on use of the resource. In other cases nodes may be using the resources with time-share (multi-threading) where each node is given partial usage of the available resource, affecting the throughput and speed of the work performed by other nodes. Timing of the tasks that are conducted by the nodes is an important consideration. Many tasks that use the same resource being concurrently conducted may result in congestion, and such scenario is a good candidate for optimization. Thus, resource optimization and contention may become a premium consideration in design of AV controller 200. To effectively carry out its function of autonomously or semi-autonomously controlling an AV, AV controller 200 may need to realize high-resource utilization and make effective and correct decision on the order of milliseconds.

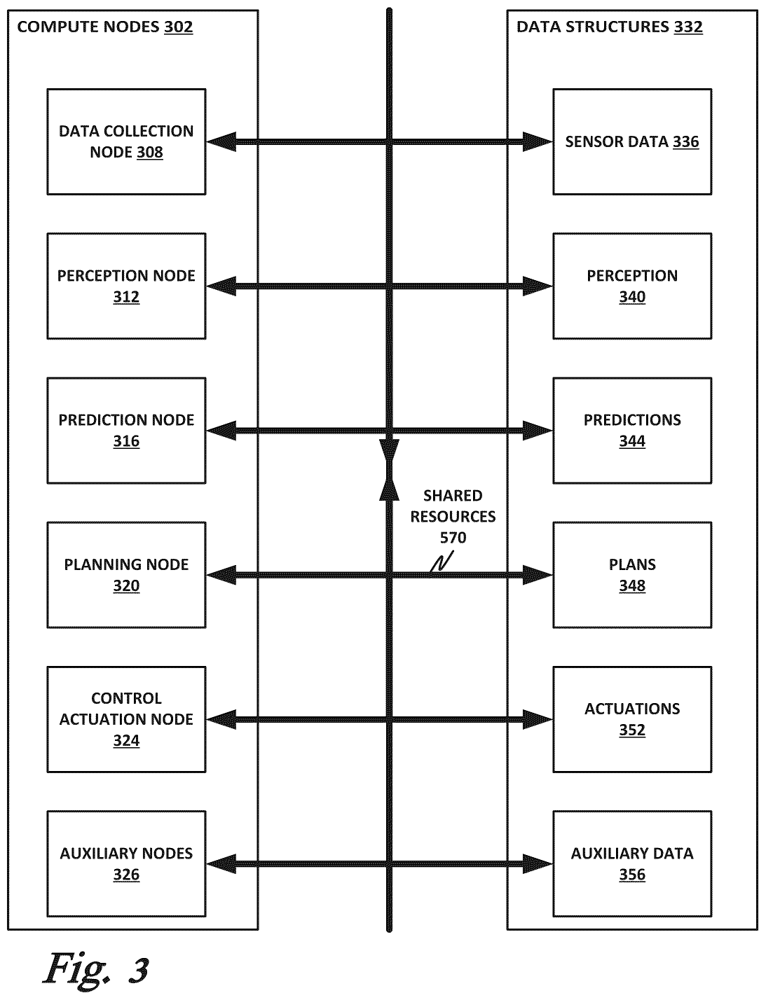

FIG. 3 is a block diagram illustration of resource utilization. Conceptually, the illustration of FIG. 3 may be thought of as extending the teachings of FIG. 2.

Specifically, FIG. 3 illustrates a number of compute nodes 302 and shared data structures 332. Compute nodes 302 compete for access to various shared resources 570. These may include hardware and/or software resources, access to data locations, access to buses, access to memory, access to processor or GPU time, or other resource contentions.

In this illustration, compute nodes 302 include one or more data collection nodes 308, one or more perception nodes 312, one or more prediction nodes 316, one or more planning nodes 320, one or more control actuation nodes 324, and one or more auxiliary nodes 326. For the sake of simplicity, only a handful of potential nodes are illustrated herein. Various embodiments of an AV controller may include other nodes than those illustrated herein, or in some cases, only some of the nodes illustrated herein.

The nodes illustrated may have different resource and data dependencies. For example, data collection node 308 may require raw data from sensors and may process the data and store sensor data 336. Perception node 312 may run a DL model that provides perceptions based on sensor data 336. For example, perception node 312 may be responsible for inferring surrounding activity, identifying traffic signals and signs, perceiving the behavior of other vehicles, or otherwise perceiving operating conditions of the AV. Perception node 312 stores its perceptions in perception data structure 340.

Prediction node 316 may be responsible for predicting operation of the vehicle and the outcomes of various potential decisions. For example, prediction node 316 may predict the results of speeding up, slowing down, turning, stopping, or performing some other action. Prediction node 316 relies on perceptions from perception data structure 340 and stores its predictions in prediction data structure 344.

Planning node 320 may be responsible for planning vehicle activity based on predictions. Planning node 320 may plan actions to take after selecting a preferred or optimal predicted action from predictions 344. Planning node 320 may store its plans in plans data structure 348.

Control actuation node 324 may access plans from plan data structure 348 and may translate those plans into actuation of available controls in the AV. Control actuation node 324 provides these actuations in actuation data structure 352, which may include signals to drive actuators to carry out the desired plans.

Various auxiliary nodes 326 may use auxiliary data structure 356 to carry out various auxiliary and support functions to support the other nodes.

As discussed above, compute nodes 302 may have data and resource dependencies on one another but do not necessarily operate serially. Some nodes may operate serially to other nodes, but many nodes may also operate in parallel to one another. For example, perception node 312 may use the latest and best available sensor data 336. Prediction node 316 may use the latest and best available perceptions 340. Planning node 320 may use the latest and best available predictions 344. Control actuation node 324 may use the latest and best available plans 348.

In some cases, a global optimizer or onboard optimizer for the AV controller may create dependency graphs that map out these dependencies on resources and data. Such dependency graphs can be used to iteratively optimize the AV controller, particularly when hardware and/or software configurations have been modified.

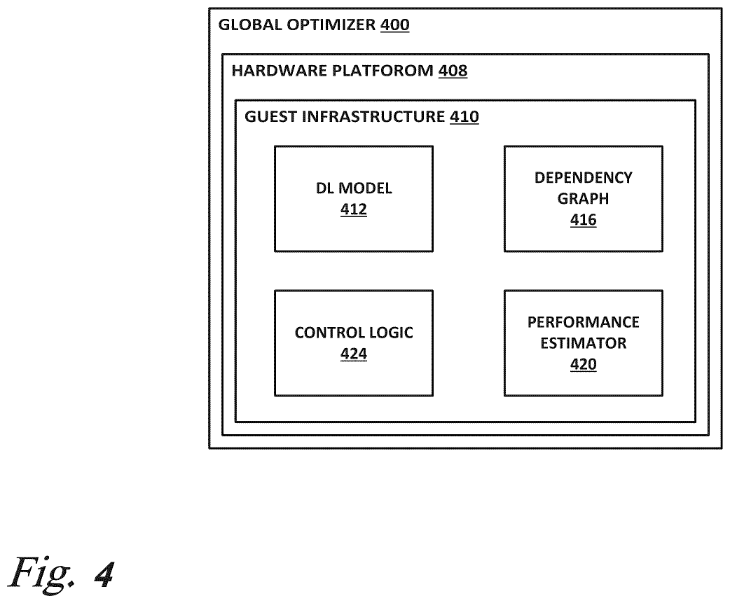

FIG. 4 is a block diagram of selected elements of a global optimizer 400. Global optimizer 400 may, in some cases, be separate from the AV controller, as illustrated in FIG. 4 and elsewhere in the specification. For example, global optimizer 400 may be hosted in a data center, such as an enterprise data center or in a cloud configuration. In other embodiments, an optimizer similar to global optimizer may be provided onboard with the AV controller so that optimization can be performed on the AV.

In this illustration, global optimizer 400 includes a hardware platform 408. Hardware platform 408 may be a hardware platform as illustrated in FIG. 6 below, or any other suitable hardware platform. In some cases, hardware platform 408 may be provided in a data center, such as via rackmounted servers and resources. In that case, the hardware platform may be disaggregated, such as by providing compute, memory, and/or different storage and/or accelerators in different physical nodes.

By way of illustration, hardware platform 408 provides a guest infrastructure 410. Guest infrastructure 410 may provide, for example, virtualization, containerization, snaps, or some other guest infrastructure that discreetly divides and sandboxes various services, applications, and/or microservices. In those cases, the logical functions illustrated here may be provided as separate services, although this is not required.

Guest infrastructure 410 hosts a DL model 412, control logic 424, dependency graph 416, and performance estimator 420. Performance estimator 420 may use dependency graph and DL model 412 to simulate or estimate the performance of a particular hardware configuration. After computing a cost function for a particular iteration, control logic 424 may then change factors, such as the number of layers or number of neurons in DL model 412, timing allocations in dependency graph 416, resource allocations, or other factors that may affect the performance of the hardware configuration. Control logic 424 may then cause performance estimator 420 to iterate through the new configuration and compute a cost function. Control logic 424 may continue to cause performance estimator 420 to iterate through different configurations until the results begin to converge and the result is considered nearly optimum enough that the selected configuration can be used in the AV controller.

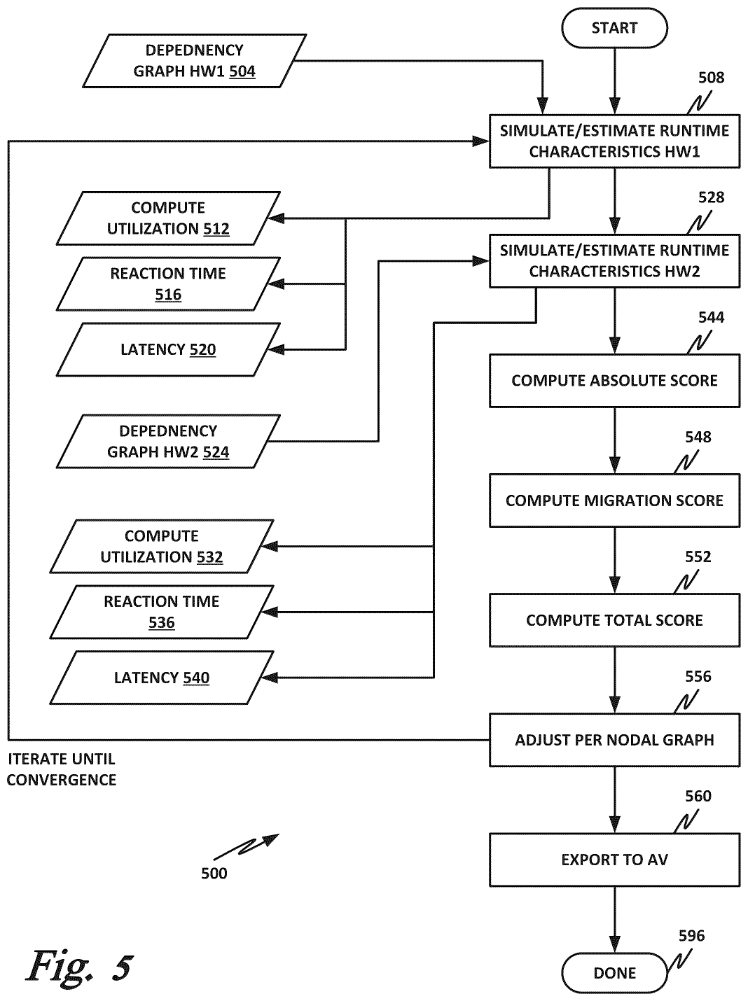

FIG. 5 is a flowchart of a method 500 of optimizing an AV controller hardware configuration.

In block 508, the optimizer receives a dependency graph 504 for hardware configuration 1. Within dependency graph 504, each node may be treated as a compute node with discrete functionality, such as perception, prediction, control, auxiliary functions, or others. Dependency graph 504 may also represent the input/output dependencies between nodes, such as which nodes depend on data from other nodes. For example, dependency graph 504 may comprise of producer nodes and consumer nodes for each input or output in the graph. Dependency graph 504 may also represent the operational configuration of each node. For example, dependency graph 504 may comprise of launch timings or conditions for each node. Launch condition may be availability of new inputs or outputs to the node, or expiration of the latest outputs, or a request received from another node. Notably, most nodes may be set to operate in parallel regardless of the I/O dependencies. This can help to maximize the utilization of system resources and increase resiliency.

In block 508, the optimizer uses a performance estimator or profiler to simulate or estimate the runtime characteristics of hardware configuration 1 with dependency graph 504. In this operation, the optimizer may, for example, estimate the compute utilization 512, such as CPU, GPU, memory, or storage utilization. It may also estimate reaction time 516, latency 520, and provide delay statistics between node launch times. These estimates are provided by way of illustrative and nonlimiting example, and other estimates and models may be used.

In block 528, the optimizer receives the dependency graph 524 for hardware configuration 2. Using this new dependency graph, in block 528, the optimizer uses a performance estimator or profiler to simulate or estimate the runtime characteristics of hardware configuration 2 based on dependency graph 524. This yields a new compute utilization 532, reaction time 536, and latency 540.

In block 544, the system computes an absolute score for the hardware configuration. Absolute score may comprise a safety score and comfort score. Safety score and comfort score may be added with a certain weight that indicates the relative importance of safety and comfort. The weights may be chosen based on business and operational constraints. The safety score may be computed by testing HW2 in a set of scenarios, which may be replays of real AV data, or simulations. These scenarios test how AV acts when faced with usual driving conditions, as well as more challenging edge cases. Score of each scenario may be computed from how safely AV operated in each scenario (no collisions, staying far enough from vulnerable road users, complying with traffic laws, no unnecessary stopping or slowing down, following the intended plan, etc.). Similarly, the comfort score is computed by measuring how comfortable the behavior of the AV was for each scenario (any sudden accelerations, decelerations, any unusual behavior, etc.). Each scenario may contribute equally to safety and comfort scores. Alternatively, each scenario may contribute differently based on the importance of the scenario and severity of the outcome of the test. Expected monetary loss or gain maybe used as a proxy to determine the weights.

In block 548, the optimizer may determine a component migration score based on differences between runtime characteristics 1 and runtime characteristics 2 of each component. The component migration score may be computed as a weighted sum of all resource usage migration scores such as memory usage improvement score, latency improvement score, contention improvement score, reaction time improvement score. These improvement scores are based on how much respective runtime performance has improved from HW1 to HW2.

In block 552, the optimizer may determine a migration score as a weighted sum of all component migration scores. It may then determine a total score based on the absolute score and the migration score.

In block 556, the optimizer may determine an adjustment on the nodal graph to minimize the total score. For example, the system may determine optimizations on DL models based on component migration scores of associated components. Optimizations on DL models may include applying quantization to reduce the precision of DL compute. Optimization of DL may also include applying model compression to reduce the number of operations of DL compute. In another example, the optimizer may determine optimization on non-DL models based on component migration scores of associated components. The optimization of non-DL models may include down-sampling resolution of sensor data. In another example, the optimization of non-DL models may include the number of clusters for a clustering algorithm. Other adjustments may be used as appropriate. The optimizer may choose from these set of options as well as adjust the parameter of each option. For example, the optimizer may look for the ideal model compression ratio number. As another example, the optimizer may look for the ideal compute precision.

After adjusting for nodal graph, the optimizer may then iterate through blocks 508 through 556 until convergence is reached. Iterations may be controlled by a reinforcement learning algorithm. Alternatively, iterations may be controlled by a numerical optimization algorithm. For example, the numerical optimization algorithm could be beam search.

After iterating through blocks 508 through 556 a sufficient number of times, an optimized hardware configuration may be found, for example, a Pareto optimization that is within approximately 20 percent of a theoretical ideal optimization. Once the preferred optimization is identified, in block 560, the optimized AV controller model may be exported to the AV controller for use in deployment.

In block 596, the method is done.

FIG. 6 is a block diagram of a hardware platform 600. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Hardware platform 600 may provide a suitable structure for controller 104 of FIG. 1, as well as for other computing elements illustrated throughout this specification, including AV controller of FIG. 2 and global optimizer 400 of FIG. 4, and other elements external to AV 102. Depending on the embodiment, elements of hardware platform 600 may be omitted, and other elements may be included.

Hardware platform 600 is configured to provide a computing device. In various embodiments, a “computing device” may be or comprise, by way of nonlimiting example, a computer, system on a chip (SoC), workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 600 is arranged in a point-to-point (PtP) configuration. This PtP configuration is popular for personal computer (PC) and server-type devices, although it is not so limited, and any other bus type may be used. The PtP configuration may be an internal device bus that is separate from CAN bus 170 of FIG. 1, although in some embodiments they may interconnect with one another.

Hardware platform 600 is an example of a platform that may be used to implement embodiments of the teachings of this specification. For example, instructions could be stored in storage 650. Instructions could also be transmitted to the hardware platform in an ethereal form, such as via a network interface, or retrieved from another source via any suitable interconnect. Once received (from any source), the instructions may be loaded into memory 604, and may then be executed by one or more processor 602 to provide elements such as an operating system 606, operational agents 608, or data 612.

Hardware platform 600 may include several processors 602. For simplicity and clarity, only processors PROC0 602-1 and PROC1 602-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 602 may be any type of processor and may communicatively couple to chipset 616 via, for example, PtP interfaces. Chipset 616 may also exchange data with other elements. In alternative embodiments, any or all of the PtP links illustrated in FIG. 6 could be implemented as any type of bus, or other configuration rather than a PtP link. In various embodiments, chipset 616 may reside on the same die or package as a processor 602 or on one or more different dies or packages. Each chipset may support any suitable number of processors 602. A chipset 616 (which may be a chipset, uncore, Northbridge, Southbridge, or other suitable logic and circuitry) may also include one or more controllers to couple other components to one or more CPUs.

Two memories, 604-1 and 604-2 are shown, connected to PROC0 602-1 and PROC1 602-2, respectively. As an example, each processor is shown connected to its memory in a direct memory access (DMA) configuration, though other memory architectures are possible, including ones in which memory 604 communicates with a processor 602 via a bus. For example, some memories may be connected via a system bus, or in a data center, memory may be accessible in a remote DMA (RDMA) configuration.

Memory 604 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 604 may be used for short, medium, and/or long-term storage. Memory 604 may store any suitable data or information utilized by platform logic. In some embodiments, memory 604 may also comprise storage for instructions that may be executed by the cores of processors 602 or other processing elements (e.g., logic resident on chipsets 616) to provide functionality.

In certain embodiments, memory 604 may comprise a relatively low-latency volatile main memory, while storage 650 may comprise a relatively higher-latency nonvolatile memory. However, memory 604 and storage 650 need not be physically separate devices, and in some examples may simply represent a logical separation of function (if there is any separation at all). It should also be noted that although DMA is disclosed by way of nonlimiting example, DMA is not the only protocol consistent with this specification, and that other memory architectures are available.

Certain computing devices provide main memory 604 and storage 650, for example, in a single physical memory device, and in other cases, memory 604 and/or storage 650 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Chipset 616 may be in communication with a bus 628 via an interface circuit. Bus 628 may have one or more devices that communicate over it, such as a bus bridge 632, I/O devices 635, accelerators 646, and communication devices 640, by way of nonlimiting example. In general terms, the elements of hardware platform 600 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 640 can broadly include any communication not covered by a network interface and the various I/O devices described herein. This may include, for example, various universal serial bus (USB), FireWire, Lightning, or other serial or parallel devices that provide communications. In a particular example, communication device 640 may be used to stream and/or receive data within a CAN. For some use cases, data may be streamed using UDP, which is unidirectional and lacks error correction. UDP may be appropriate for cases where latency and overhead are at a higher premium than error correction. If bi-directional and/or error corrected communication are desired, then a different protocol, such as TCP may be preferred.

I/O devices 635 may be configured to interface with any auxiliary device that connects to hardware platform 600 but that is not necessarily a part of the core architecture of hardware platform 600. A peripheral may be operable to provide extended functionality to hardware platform 600 and may or may not be wholly dependent on hardware platform 600. In some cases, a peripheral may itself be a. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

Bus bridge 632 may be in communication with other devices such as a keyboard/mouse 638 (or other input devices such as a touch screen, trackball, etc.), communication devices 640 (such as modems, network interface devices, peripheral interfaces such as PCI or PCIe, or other types of communication devices that may communicate through a network), and/or accelerators 646. In alternative embodiments, any portions of the bus architectures could be implemented with one or more PtP links.

Operating system 606 may be, for example, Microsoft Windows, Linux, UNIX, Mac OS X, iOS, MS-DOS, or an embedded or real-time operating system (including embedded or real-time flavors of the foregoing). For real-time systems such as an AV, various forms of QNX are popular. In some embodiments, a hardware platform 600 may function as a host platform for one or more guest systems that invoke application (e.g., operational agents 608).

Operational agents 608 may include one or more computing engines that may include one or more non-transitory computer-readable mediums having stored thereon executable instructions operable to instruct a processor to provide operational functions. At an appropriate time, such as upon booting hardware platform 600 or upon a command from operating system 606 or a user or security administrator, a processor 602 may retrieve a copy of the operational agent (or software portions thereof) from storage 650 and load it into memory 604. Processor 602 may then iteratively execute the instructions of operational agents 608 to provide the desired methods or functions.

There are described throughout this specification various engines, modules, agents, servers, or functions. Each of these may include any combination of one or more logic elements of similar or dissimilar species, operable for and configured to perform one or more methods provided by the engine. In some cases, the engine may be or include a special integrated circuit designed to carry out a method or a part thereof, an FPGA programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language. These may be used with any compatible operating systems or operating environments. Hardware elements may be designed manually, or with a hardware description language. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

Communication devices 640 may communicatively couple hardware platform 600 to a wired or wireless network or fabric. A “network,” as used throughout this specification, may include any communicative platform operable to exchange data or information within or between computing devices, including any of the protocols discussed in connection with FIG. 1 above. A network interface may include one or more physical ports that may couple to a cable (e.g., an Ethernet cable, other cable, or waveguide), or a wireless transceiver.

In some cases, some or all of the components of hardware platform 600 may be virtualized, in particular the processor(s) and memory. For example, a virtualized environment may run on OS 606, or OS 606 could be replaced with a hypervisor or virtual machine manager. In this configuration, a virtual machine running on hardware platform 600 may virtualize workloads. A virtual machine in this configuration may perform essentially all the functions of a physical hardware platform.

In a general sense, any suitably configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 6 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in ASICs, FPGAs, and other semiconductor chips.

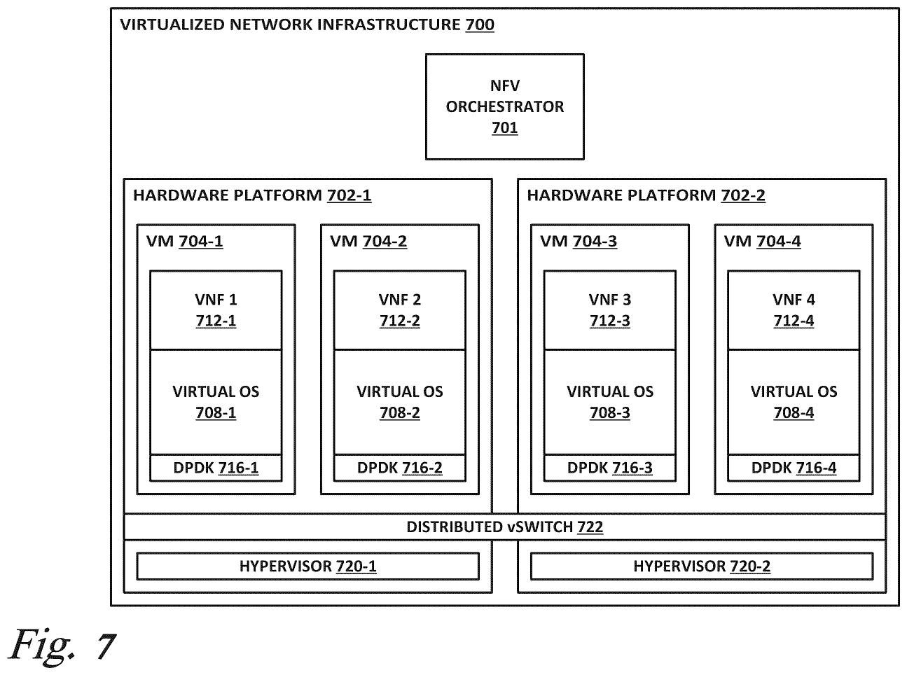

FIG. 7 is a block diagram of a NFV infrastructure 700. NFV is an example of virtualization, and the virtualization infrastructure here can also be used to realize traditional Virtual Machines (VMs). Various functions described above may be realized as VMs, such as embodiments of global optimizer 400 of FIG. 4.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 700. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 7, an NFV orchestrator 701 may manage several VNFs 712 running on an NFVI 700. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 701 a valuable system resource. Note that NFV orchestrator 701 may provide a browser-based or graphical configuration interface, and in some embodiments may be integrated with SDN orchestration functions.

Note that NFV orchestrator 701 itself may be virtualized (rather than a special-purpose hardware appliance). NFV orchestrator 701 may be integrated within an existing SDN system, wherein an operations support system (OSS) manages the SDN. This may interact with cloud resource management systems (e.g., OpenStack) to provide NFV orchestration. An NFVI 700 may include the hardware, software, and other infrastructure to enable VNFs to run. This may include a hardware platform 702 on which one or more VMs 704 may run. For example, hardware platform 702-1 in this example runs VMs 704-1 and 704-2. Hardware platform 702-2 runs VMs 704-3 and 704-4. Each hardware platform 702 may include a respective hypervisor 720, virtual machine manager (VMM), or similar function, which may include and run on a native (bare metal) operating system, which may be minimal so as to consume very few resources. For example, hardware platform 702-1 has hypervisor 720-1, and hardware platform 702-2 has hypervisor 720-2.

Hardware platforms 702 may be or comprise a rack or several racks of blade or slot servers (including, e.g., processors, memory, and storage), one or more data centers, other hardware resources distributed across one or more geographic locations, hardware switches, or network interfaces. An NFVI 700 may also include the software architecture that enables hypervisors to run and be managed by NFV orchestrator 701.

Running on NFVI 700 are VMs 704, each of which in this example is a VNF providing a virtual service appliance. Each VM 704 in this example includes an instance of the Data Plane Development Kit (DPDK) 716, a virtual operating system 708, and an application providing the VNF 712. For example, VM 704-1 has virtual OS 708-1, DPDK 716-1, and VNF 712-1. VM 704-2 has virtual OS 708-2, DPDK 716-2, and VNF 712-2. VM 704-3 has virtual OS 708-3, DPDK 716-3, and VNF 712-3. VM 704-4 has virtual OS 708-4, DPDK 716-4, and VNF 712-4.

Virtualized network functions could include, as nonlimiting and illustrative examples, firewalls, intrusion detection systems, load balancers, routers, session border controllers, DPI services, network address translation (NAT) modules, or call security association.

The illustration of FIG. 7 shows that a number of VNFs 704 have been provisioned and exist within NFVI 700. This FIGURE does not necessarily illustrate any relationship between the VNFs and the larger network, or the packet flows that NFVI 700 may employ.

The illustrated DPDK instances 716 provide a set of highly optimized libraries for communicating across a virtual switch (vSwitch) 722. Like VMs 704, vSwitch 722 is provisioned and allocated by a hypervisor 720. The hypervisor uses a network interface to connect the hardware platform to the data center fabric (e.g., a host fabric interface (HFI)). This HFI may be shared by all VMs 704 running on a hardware platform 702. Thus, a vSwitch may be allocated to switch traffic between VMs 704. The vSwitch may be a pure software vSwitch (e.g., a shared memory vSwitch), which may be optimized so that data are not moved between memory locations, but rather, the data may stay in one place, and pointers may be passed between VMs 704 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 722 is illustrated, wherein vSwitch 722 is shared between two or more physical hardware platforms 702.

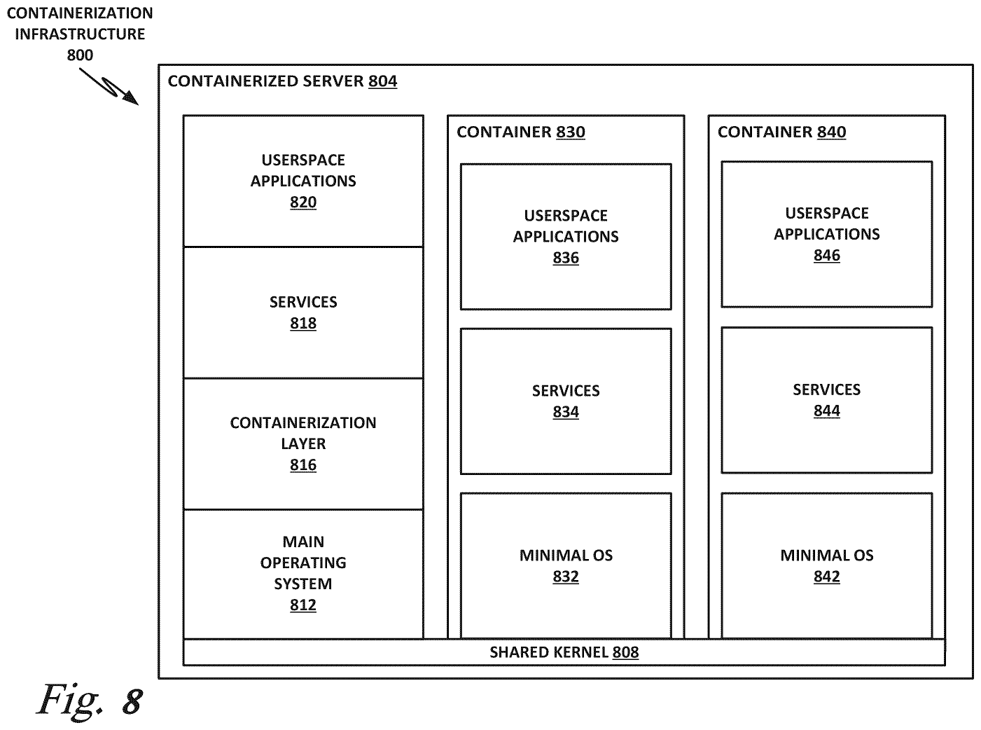

FIG. 8 is a block diagram of selected elements of a containerization infrastructure 800. Like virtualization, containerization is a popular form of providing a guest infrastructure. Various functions described herein may be containerized, such as embodiments of global optimizer 400 of FIG. 4.

Containerization infrastructure 800 runs on a hardware platform such as containerized server 804. Containerized server 804 may provide processors, memory, one or more network interfaces, accelerators, and/or other hardware resources.

Running on containerized server 804 is a shared kernel 808. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 808 is main operating system 812. Commonly, main operating system 812 is a Unix or Linux-based operating system, although containerization infrastructure is also available for other types of systems, including Microsoft Windows systems and Macintosh systems. Running on top of main operating system 812 is a containerization layer 816. For example, Docker is a popular containerization layer that runs on a number of operating systems and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 812 may also provide services 818, which provide services and interprocess communication to userspace applications 820.

Services 818 and userspace applications 820 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 812, they inherit the same file and resource access permissions as those provided by shared kernel 808. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 804, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 804).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors-especially type 1, or “bare metal,” hypervisors-provide such near-native performance that this advantage may not always be realized.

In this example, containerized server 804 hosts two containers, namely container 830 and container 840.

Container 830 may include a minimal operating system 832 that runs on top of shared kernel 808. Note that a minimal operating system is provided as an illustrative example and is not mandatory. In fact, container 830 may perform as full an operating system as is necessary or desirable. Minimal operating system 832 is used here as an example simply to illustrate that in common practice, the minimal operating system necessary to support the function of the container (which in common practice, is a single or monolithic function) is provided.

On top of minimal operating system 832, container 830 may provide one or more services 834. Finally, on top of services 834, container 830 may also provide userspace applications 836, as necessary.

Container 840 may include a minimal operating system 842 that runs on top of shared kernel 808. Note that a minimal operating system is provided as an illustrative example and is not mandatory. In fact, container 840 may perform as full an operating system as is necessary or desirable. Minimal operating system 842 is used here as an example simply to illustrate that in common practice, the minimal operating system necessary to support the function of the container (which in common practice, is a single or monolithic function) is provided.

On top of minimal operating system 842, container 840 may provide one or more services 844. Finally, on top of services 844, container 840 may also provide userspace applications 846, as necessary.

Using containerization layer 816, containerized server 804 may run discrete containers, each one providing the minimal operating system and/or services necessary to provide a particular function. For example, containerized server 804 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

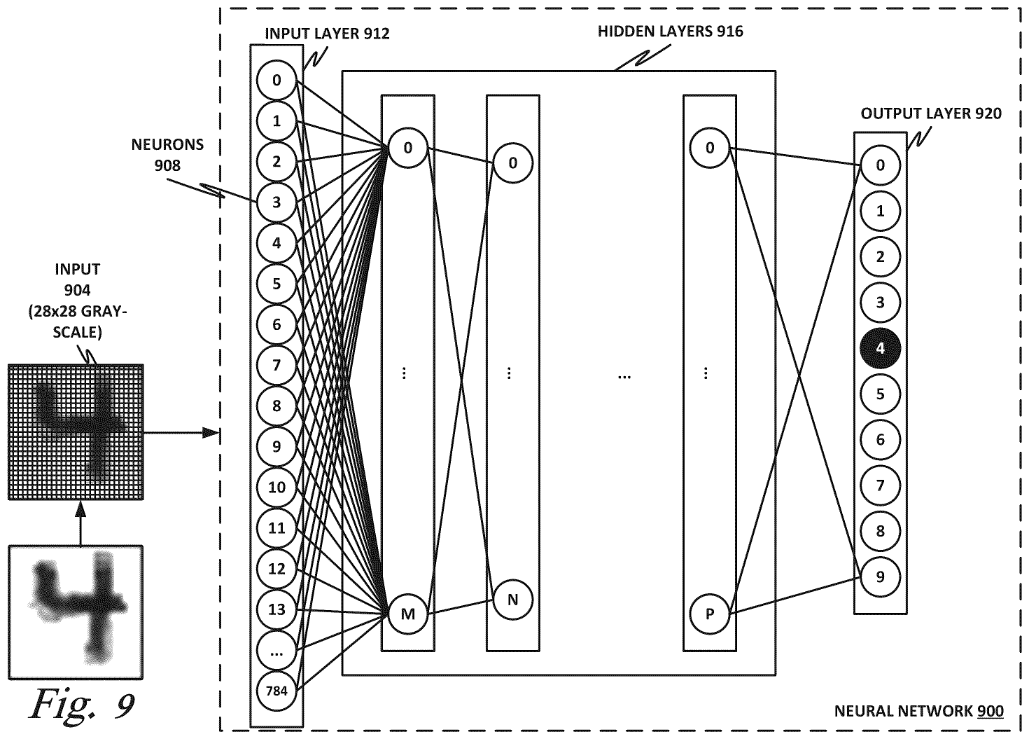

FIGS. 9-11 illustrate selected elements of an AI system or architecture. In these FIGURES, an elementary neural network is used as a representative embodiment of an AI or machine learning architecture or engine. This should be understood to be a nonlimiting example, and other machine learning or AI architectures are available, including for example symbolic learning, robotics, computer vision, pattern recognition, statistical learning, speech recognition, natural language processing, DL, convolutional neural networks, recurrent neural networks, object recognition and/or others.

In particular, any of the machine learning and/or DL models discussed herein (e.g., DL model 412 of FIG. 4) may be provided by an AI system that works conceptually as illustrated. It should be noted that FIGS. 9-11 below provide only a basic and illustrative structure for the DL models. In practice, the models may include features and operations different from and/or in addition to those illustrated herein. Many variations, deviations, and methods are known in the art of deep learning, and the model illustrated here is intended to stand as an illustrative example that represents all known DL models as a class.

FIG. 9 illustrates machine learning according to an exemplary problem with real-world applications. In this case, a neural network 900 is tasked with recognizing characters for illustration (neural network 900 may be implemented in compute nodes 302 of FIG. 3 to perform other AV-related tasks). To simplify the description, neural network 900 is tasked only with recognizing single digits in the range of 0 through 9. These are provided as an input image 904. In this example, input image 904 is a 28×28-pixel 8-bit grayscale image. In other words, input image 904 is a square that is 28 pixels wide and 28 pixels high. Each pixel has a value between 0 and 255, with 0 representing white or no color, and 255 representing black or full color, with values in between representing various shades of gray. This provides a straightforward problem space to illustrate the operative principles of a neural network. Only selected elements of neural network 900 are illustrated in this FIGURE, and that real-world applications may be more complex, and may include additional features, such as the use of multiple channels (e.g., for a color image, there may be three distinct channels for red, green, and blue). Additional layers of complexity or functions may be provided in a neural network, or other AI architecture, to meet the demands of a particular problem. Indeed, the architecture here is sometimes referred to as the “Hello World” problem of machine learning and is provided as but one example of how the machine learning or AI functions of the present specification could be implemented.

In this case, neural network 900 includes an input layer 912 and an output layer 920. In principle, input layer 912 receives an input such as input image 904, and at output layer 920, neural network 900 “lights up” a perceptron that indicates which character neural network 900 thinks is represented by input image 904.

Between input layer 912 and output layer 920 are some number of hidden layers 916. The number of hidden layers 916 will depend on the problem to be solved, the available compute resources, and other design factors. In general, the more hidden layers 916, and the more neurons per hidden layer, the more accurate the neural network 900 may become. However, adding hidden layers and neurons also increases the complexity of the neural network, and its demand on compute resources. Thus, some design skill is required to determine the appropriate number of hidden layers 916, and how many neurons are to be represented in each hidden layer 916.

Input layer 912 includes, in this example, 784 “neurons” 908. Each neuron of input layer 912 receives information from a single pixel of input image 904. Because input image 904 is a 28×28 grayscale image, it has 784 pixels. Thus, each neuron in input layer 912 holds 8 bits of information, taken from a pixel of input layer 904. This 8-bit value is the “activation” value for that neuron.

Each neuron in input layer 912 has a connection to each neuron in the first hidden layer in the network. In this example, the first hidden layer has neurons labeled 0 through M. Each of the M+1 neurons is connected to all 784 neurons in input layer 912. Each neuron in hidden layer 916 includes a kernel or transfer function, which is described in greater detail below. The kernel or transfer function determines how much “weight” to assign each connection from input layer 912. In other words, a neuron in hidden layer 916 may think that some pixels are more important to its function than other pixels. Based on this transfer function, each neuron computes an activation value for itself, which may be for example a decimal number between 0 and 1.

A common operation for the kernel is convolution, in which case the neural network may be referred to as a “convolutional neural network” (CNN). The case of a network with multiple hidden layers between the input layer and output layer may be referred to as a “deep neural network” (DNN). A DNN may be a CNN, and a CNN may be a DNN, but neither expressly implies the other.

Each neuron in this layer is also connected to each neuron in the next layer, which has neurons from 0 to N. As in the previous layer, each neuron has a transfer function that assigns a particular weight to each of its M+1 connections and computes its own activation value. In this manner, values are propagated along hidden layers 916, until they reach the last layer, which has P+1 neurons labeled 0 through P. Each of these P+1 neurons has a connection to each neuron in output layer 920. Output layer 920 includes a number of neurons known as perceptrons that compute an activation value based on their weighted connections to each neuron in the last hidden layer 916. The final activation value computed at output layer 920 may be thought of as a “probability” that input image 904 is the value represented by the perceptron. For example, if neural network 900 operates perfectly, then perceptron 4 would have a value of 1.00, while each other perceptron would have a value of 0.00. This would represent a theoretically perfect detection. In practice, detection is not generally expected to be perfect, but it is desirable for perceptron 4 to have a value close to 1, while the other perceptrons have a value close to 0.

Conceptually, neurons in the hidden layers 916 may correspond to “features.” For example, in the case of computer vision, the task of recognizing a character may be divided into recognizing features such as the loops, lines, curves, or other features that make up the character. Recognizing each loop, line, curve, etc., may be further divided into recognizing smaller elements (e.g., line or curve segments) that make up that feature. Moving through the hidden layers from left to right, it is often expected and desired that each layer recognizes the “building blocks” that make up the features for the next layer. In practice, realizing this effect is itself a nontrivial problem, and may require greater sophistication in programming and training than is fairly represented in this simplified example.

The activation value for neurons in the input layer is simply the value taken from the corresponding pixel in the bitmap. The activation value (a) for each neuron in succeeding layers is computed according to a transfer function, which accounts for the “strength” of each of its connections to each neuron in the previous layer. The transfer can be written as a sum of weighted inputs (i.e., the activation value (a) received from each neuron in the previous layer, multiplied by a weight representing the strength of the neuron-to-neuron connection (w)), plus a bias value.

The weights may be used, for example, to “select” a region of interest in the pixmap that corresponds to a “feature” that the neuron represents. Positive weights may be used to select the region, with a higher positive magnitude representing a greater probability that a pixel in that region (if the activation value comes from the input layer) or a subfeature (if the activation value comes from a hidden layer) corresponds to the feature. Negative weights may be used for example to actively “de-select” surrounding areas or subfeatures (e.g., to mask out lighter values on the edge), which may be used for example to clean up noise on the edge of the feature. Pixels or subfeatures far removed from the feature may have for example a weight of zero, meaning those pixels should not contribute to examination of the feature.

The bias (b) may be used to set a “threshold” for detecting the feature. For example, a large negative bias indicates that the “feature” should be detected only if it is strongly detected, while a large positive bias makes the feature much easier to detect.

The biased weighted sum yields a number with an arbitrary sign and magnitude. This real number can then be normalized to a final value between 0 and 1, representing (conceptually) a probability that the feature this neuron represents was detected from the inputs received from the previous layer. Normalization may include a function such as a step function, a sigmoid, a piecewise linear function, a Gaussian distribution, a linear function or regression, or the popular “rectified linear unit” (ReLU) function. In the examples of this specification, a sigmoid function notation (a) is used by way of illustrative example, but it should be understood to stand for any normalization function or algorithm used to compute a final activation value in a neural network.

The transfer function for each neuron in a layer yields a scalar value. For example, the activation value for neuron “0” in layer “1” (the first hidden layer), may be written as:

a₀⁽¹⁾=σ(w₀a₀⁽⁰⁾+w₁a₁⁽⁰⁾+ . . . w₇₈₃a₇₈₃+b)

In this case, it is assumed that layer 0 (input layer 912) has 784 neurons. Where the previous layer has “n” neurons, the function can be generalized as:

a₀⁽¹⁾=σ(w₀a₀⁽⁰⁾+w₁a₁⁽⁰⁾+ . . . wₙaₙ+b)

A similar function is used to compute the activation value of each neuron in layer 1 (the first hidden layer), weighted with that neuron's strength of connections to each neuron in layer 0, and biased with some threshold value. As discussed above, the sigmoid function shown here is intended to stand for any function that normalizes the output to a value between 0 and 1.

The full transfer function for layer 1 (with k neurons in layer 1) may be written in matrix notation as:

$${a}^{( 1 )} = σ ( [ \begin{matrix}{w}_{0 , 0} & … & {w}_{0 , n} \\ ⋮ & ⋱ & ⋮ \\ {w}_{( k , 0 )} & … & {w}_{k , n}\end{matrix} ] [ \begin{matrix}{a}_{0}^{( 0 )} \\ ⋮ \\ {a}_{n}^{( 0 )}\end{matrix} ] + [ \begin{matrix}{b}_{0} \\ ⋮ \\ {b}_{n}\end{matrix} ] )$$

More compactly, the full transfer function for layer 1 can be written in vector notation as:

a⁽¹⁾=σ(Wa⁽⁰⁾+b)

Neural connections and activation values are propagated throughout the hidden layers 916 of the network in this way, until the network reaches output layer 920. At output layer 920, each neuron is a “bucket” or classification, with the activation value representing a probability that the input object should be classified to that perceptron. The classifications may be mutually exclusive or multinominal. For example, in the computer vision example of character recognition, a character may best be assigned only one value, or in other words, a single character is not expected to be simultaneously both a “4” and a “9.” In that case, the neurons in output layer 920 are binomial perceptrons. Ideally, only one value is above the threshold, causing the perceptron to metaphorically “light up,” and that value is selected. In the case where multiple perceptrons light up, the one with the highest probability may be selected. The result is that only one value (in this case, “4”) should be lit up, while the rest should be “dark.” Indeed, if the neural network were theoretically perfect, the “4” neuron would have an activation value of 1.00, while each other neuron would have an activation value of 0.00.

In the case of multinominal perceptrons, more than one output may be lit up. In the case of multinominal classification, a threshold may be defined, and any neuron in the output layer with a probability above the threshold may be considered a “match”. Those below the threshold are considered not a match.

The weights and biases of the neural network act as parameters, or “controls,” wherein features in a previous layer are detected and recognized. When the neural network is first initialized, the weights and biases may be assigned randomly or pseudo-randomly. Thus, because the weights and biases controls are garbage, the initial output is expected to be garbage. In the case of a “supervised” learning algorithm, the network is refined by providing a “training” set, which includes objects with known results. Because the correct answer for each object is known, training sets can be used to iteratively move the weights and biases away from garbage values, and toward more useful values.

A common method for refining values includes “gradient descent” and “back-propagation.” An illustrative gradient descent method includes computing a “cost” function, which measures the error in the network. For example, in the illustration, the “4” perceptron ideally has a value of “1.00,” while the other perceptrons have an ideal value of “0.00.” The cost function takes the difference between each output and its ideal value, squares the difference, and then takes a sum of all of the differences. Each training example will have its own computed cost. Initially, the cost function is very large, because the network does not know how to classify objects. As the network is trained and refined, the cost function value is expected to get smaller, as the weights and biases are adjusted toward more useful values.

With, for example, 100,000 training examples in play, an average cost (e.g., a mathematical mean) can be computed across all 100,00 training examples. This average cost provides a quantitative measurement of how “badly” the neural network is doing its detection job.

The cost function can thus be thought of as a single, very complicated formula, where the inputs are the parameters (weights and biases) of the network. Because the network may have thousands or even millions of parameters, the cost function has thousands or millions of input variables. The output is a single value representing a quantitative measurement of the error of the network. The cost function can be represented as:

C(w)

Wherein w is a vector containing all of the parameters (weights and biases) in the network. The minimum (absolute and/or local) can then be represented as a trivial calculus problem, namely:

$$\frac{d C}{d w} ( w ) = 0$$

Solving such a problem symbolically may be prohibitive, and in some cases not even possible, even with heavy computing power available. Rather, neural networks commonly solve the minimizing problem numerically. For example, the network can compute the slope of the cost function at any given point, and then shift by some small amount depending on whether the slope is positive or negative. The magnitude of the adjustment may depend on the magnitude of the slope. For example, when the slope is large, it is expected that the local minimum is “far away,” so larger adjustments are made. As the slope lessens, smaller adjustments are made to avoid badly overshooting the local minimum. In terms of multi-vector calculus, this is a gradient function of many variables:

−∇C(w)

The value of −∇C is simply a vector of the same number of variables as w, indicating which direction is “down” for this multivariable cost function. For each value in −∇C, the sign of each scalar tells the network which “direction” the value needs to be nudged, and the magnitude of each scalar can be used to infer which values are most “important” to change.

Gradient descent involves computing the gradient function, taking a small step in the “downhill” direction of the gradient (with the magnitude of the step depending on the magnitude of the gradient), and then repeating until a local minimum has been found within a threshold.

While finding a local minimum is relatively straightforward once the value of −∇C, finding an absolute| minimum is many times harder, particularly when the function has thousands or millions of variables. Thus, common neural networks consider a local minimum to be “good enough,” with adjustments possible if the local minimum yields unacceptable results. Because the cost function is ultimately an average error value over the entire training set, minimizing the cost function yields a (locally) lowest average error.

In many cases, the most difficult part of gradient descent is computing the value of −∇C. As mentioned above, computing this symbolically or exactly would be prohibitively difficult. A more practical method is to use back-propagation to numerically approximate a value for −∇C. Back-propagation may include, for example, examining an individual perceptron at the output layer, and determining an average cost value for that perceptron across the whole training set. Taking the “4” perceptron as an example, if the input image is a 4, it is desirable for the perceptron to have a value of 1.00, and for any input images that are not a 4, it is desirable to have a value of 0.00. Thus, an overall or average desired adjustment for the “4” perceptron can be computed.

However, the perceptron value is not hard-coded, but rather depends on the activation values received from the previous layer. The parameters of the perceptron itself (weights and bias) can be adjusted, but it may also be desirable to receive different activation values from the previous layer. For example, where larger activation values are received from the previous layer, the weight is multiplied by a larger value, and thus has a larger effect on the final activation value of the perceptron. The perceptron metaphorically “wishes” that certain activations from the previous layer were larger or smaller. Those wishes can be back-propagated to the previous layer neurons.

At the next layer, the neuron accounts for the wishes from the next downstream layer in determining its own preferred activation value. Again, at this layer, the activation values are not hard-coded. Each neuron can adjust its own weights and biases, and then back-propagate changes to the activation values that it wishes would occur. The back-propagation continues, layer by layer, until the weights and biases of the first hidden layer are set. This layer cannot back-propagate desired changes to the input layer, because the input layer receives activation values directly from the input image.

After a round of such nudging, the network may receive another round of training with the same or a different training data set, and the process is repeated until a local and/or global minimum value is found for the cost function.

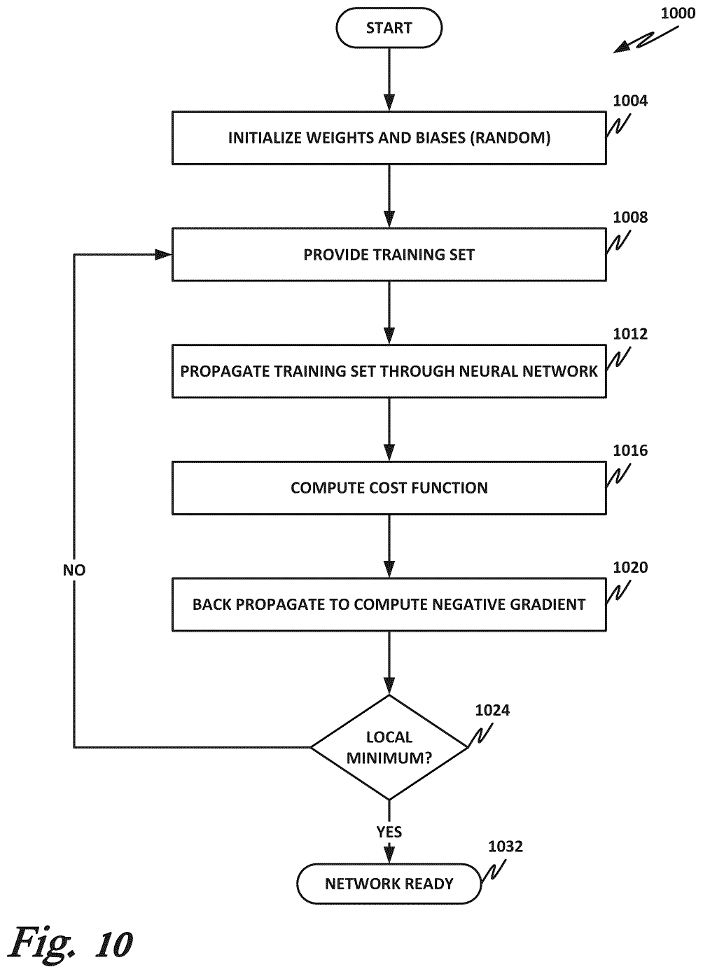

FIG. 10 is a flowchart of a method 1000. Method 1000 may be used to train a neural network, such as neural network 900 of FIG. 9.

In block 1004, the network is initialized. Initially, neural network 900 includes some number of neurons. Each neuron includes a transfer function or kernel. In the case of a neural network, each neuron includes parameters such as the weighted sum of values of each neuron from the previous layer, plus a bias. The final value of the neuron may be normalized to a value between 0 and 1, using a function such as the sigmoid or ReLU. Because the untrained neural network knows nothing about its problem space, and because it would be very difficult to manually program the neural network to perform the desired function, the parameters for each neuron may initially be set to just some random value. For example, the values may be selected using a pseudorandom number generator of a CPU, and then assigned to each neuron.

In block 1008, the neural network is provided a training set. In some cases, the training set may be divided up into smaller groups. For example, if the training set has 100,000 objects, this may be divided into 1,000 groups, each having 100 objects. These groups can then be used to incrementally train the neural network. In block 1008, the initial training set is provided to the neural network. Alternatively, the full training set could be used in each iteration.

In block 1012, the training data are propagated through the neural network. Because the initial values are random, and are therefore essentially garbage, it is expected that the output will also be a garbage value. In other words, if neural network 900 of FIG. 9 has not been trained, when input image 904 is fed into the neural network, it is not expected with the first training set that output layer 920 will light up perceptron 4. Rather, the perceptrons may have values that are all over the map, with no clear winner, and with very little relation to the number 4.

In block 1016, a cost function is computed as described above. For example, in neural network 900, it is desired for perceptron 4 to have a value of 1.00, and for each other perceptron to have a value of 0.00. The difference between the desired value and the actual output value is computed and squared. Individual cost functions can be computed for each training input, and the total cost function for the network can be computed as an average of the individual cost functions.

In block 1020, the network may then compute a negative gradient of this cost function to seek a local minimum value of the cost function, or in other words, the error. For example, the system may use back-propagation to seek a negative gradient numerically. After computing the negative gradient, the network may adjust parameters (weights and biases) by some amount in the “downward” direction of the negative gradient.

After computing the negative gradient, in decision block 1024, the system determines whether it has reached a local minimum (e.g., whether the gradient has reached 0 within the threshold). If the local minimum has not been reached, then the neural network has not been adequately trained, and control returns to block 1008 with a new training set. The training sequence continues until, in block 1024, a local minimum has been reached.

Now that a local minimum has been reached and the corrections have been back-propagated, in block 1032, the neural network is ready.

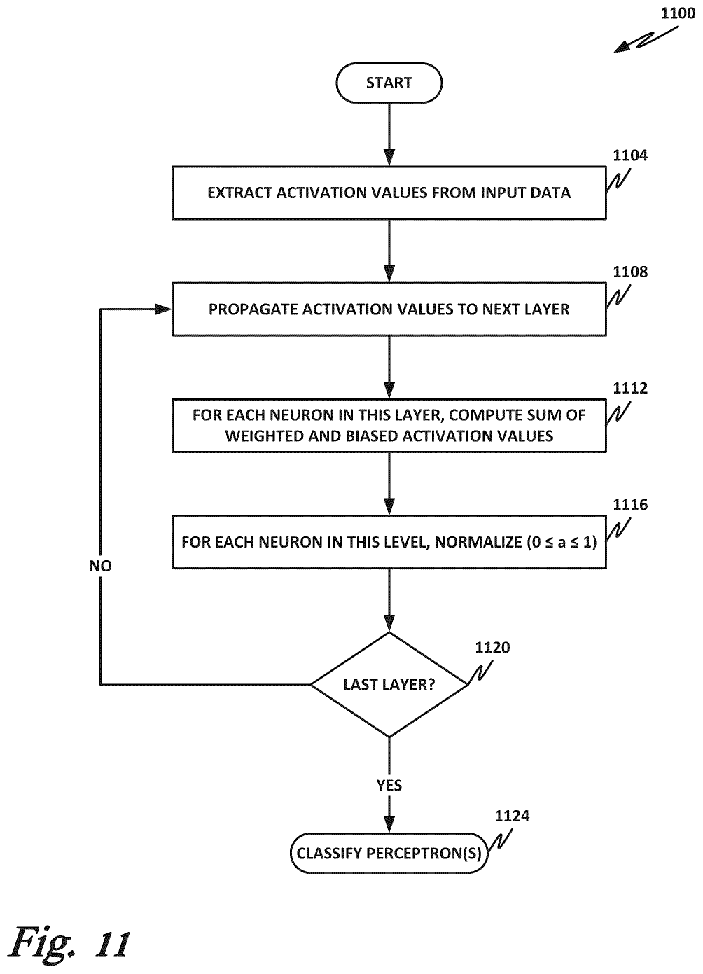

FIG. 11 is a flowchart of a method 1100. Method 1100 illustrates a method of using a neural network, such as network 900 of FIG. 9, to classify an object.

In block 1104, the network extracts the activation values from the input data. For example, in the example of FIG. 9, each pixel in input image 904 is assigned as an activation value to a neuron 908 in input layer 912.

In block 1108, the network propagates the activation values from the current layer to the next layer in the neural network. For example, after activation values have been extracted from the input image, those values may be propagated to the first hidden layer of the network.

In block 1112, for each neuron in the current layer, the neuron computes a sum of weighted and biased activation values received from each neuron in the previous layer. For example, in the illustration of FIG. 9, neuron 0 of the first hidden layer is connected to each neuron in input layer 912. A sum of weighted values is computed from those activation values, and a bias is applied.

In block 1116, for each neuron in the current layer, the network normalizes the activation values by applying a function such as sigmoid, ReLU, or some other function.

In decision block 1120, the network determines whether it has reached the last layer in the network. If this is not the last layer, then control passes back to block 1108, where the activation values in this layer are propagated to the next layer.

Returning to decision block 1120, If the network is at the last layer, then the neurons in this layer are perceptrons that provide final output values for the object. In terminal 1124, the perceptrons are classified and used as output values.

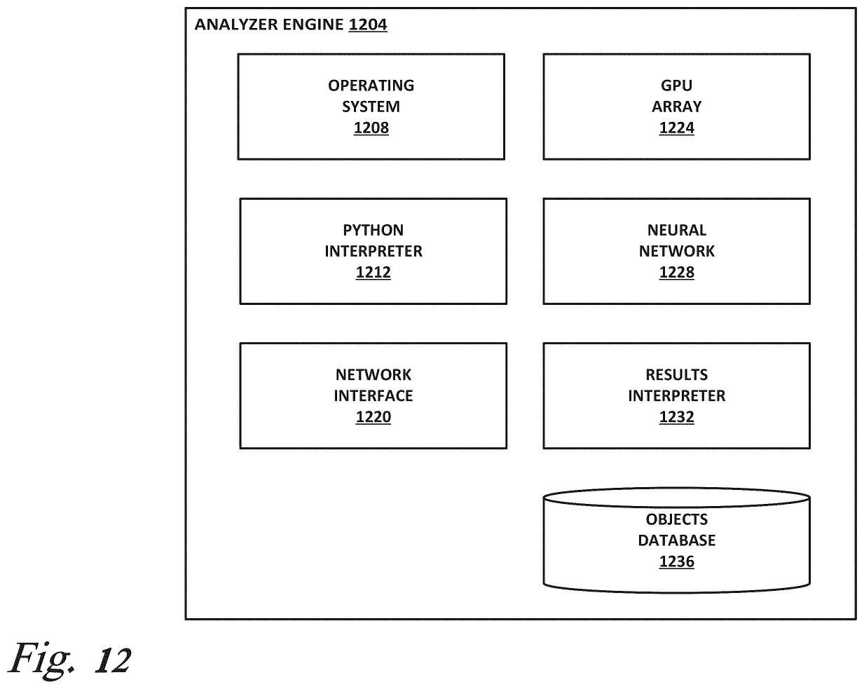

FIG. 12 is a block diagram illustrating selected elements of an analyzer engine 1204. Analyzer engine 1204 may be configured to provide analysis services, such as via a neural network. FIG. 12 illustrates a platform for providing analysis services. Analysis, such as neural analysis and other machine learning models, may be used in some embodiments to provide one or more features of the present disclosure.

Note that analyzer engine 1204 is illustrated here as a single modular object, but in some cases, different aspects of analyzer engine 1204 could be provided by separate hardware, or by separate guests (e.g., VMs or containers) on a hardware system.

Analyzer engine 1204 includes an operating system 1208. Commonly, operating system 1208 is a Linux operating system, although other operating systems, such as Microsoft Windows, Mac OS X, UNIX, or similar could be used. Analyzer engine 1204 also includes a Python interpreter 1212, which can be used to run Python programs. A Python module known as Numerical Python (NumPy) is often used for neural network analysis. Although this is a popular choice, other non-Python or non-NumPy systems could also be used. For example, the neural network could be implemented in Matrix Laboratory (MATLAB), C, C++, Fortran, R, or some other compiled or interpreted computer language.

GPU array 1224 may include an array of graphics processing units that may be used to carry out the neural network functions of neural network 1228. Note that GPU arrays are a popular choice for this kind of processing, but neural networks can also be implemented in CPUs, or in ASICs or FPGAs that are specially designed to implement the neural network.

Neural network 1228 includes the actual code for carrying out the neural network, and as mentioned above, is commonly programmed in Python.

Results interpreter 1232 may include logic separate from the neural network functions that can be used to operate on the outputs of the neural network to assign the object for particular classification, perform additional analysis, and/or provide a recommended remedial action.

Objects database 1236 may include a database of known malware objects and their classifications. Neural network 1228 may initially be trained on objects within objects database 1236, and as new objects are identified, objects database 1236 may be updated with the results of additional neural network analysis.

Once final results have been obtained, the results may be sent to an appropriate destination via network interface 1220.

### Selected Examples

There is disclosed in an example of a computing apparatus, comprising: a processor circuit and a memory; and instructions encoded within the memory to instruct the processor circuit to: receive a stored dependency graph for a first hardware configuration for a plurality of compute nodes; receive a second hardware configuration comprising a modification to the first hardware configuration; iteratively model the second hardware configuration comprising adjusting one or more of a plurality of operational parameters for a model of the second hardware configuration, and selecting an optimum configuration of the plurality of operational parameters; and sending the optimum configuration to a real-world embodiment of the second hardware configuration.

There is also disclosed an example of the computing apparatus, wherein the plurality of operational parameters include access to shared resources.

There is also disclosed an example of the computing apparatus, wherein a majority of the plurality of compute nodes are to operate in parallel with one another.

There is also disclosed an example of the computing apparatus, wherein the plurality of compute nodes comprise a first compute node with a data dependency on a second compute node, wherein the first compute node and second compute node are to operate in parallel with one another.

There is also disclosed an example of the computing apparatus, wherein the first compute node is to use latest available data from the second compute node.

There is also disclosed an example of the computing apparatus, wherein the model is a machine learning model.

There is also disclosed an example of the computing apparatus, wherein the model is a statistical model.

There is also disclosed an example of the computing apparatus, wherein iteratively modeling the second hardware configuration comprises iteratively modeling until a predicted performance for the second hardware configuration reaches a convergence.

There is also disclosed an example of the computing apparatus, wherein the optimum configuration is optimum to within a Pareto criterion.

There is also disclosed an example of the computing apparatus, wherein at least one of the plurality of compute nodes comprises a deep learning (DL) model, and adjusting the plurality of operational parameters comprises adjusting a number of intermediate layers in the DL model.

There is also disclosed an example of the computing apparatus, wherein at least one of the plurality of compute nodes comprises a deep learning (DL) model, and adjusting the plurality of operational parameters comprises adjusting a precision of the DL model.

There is also disclosed an example of the computing apparatus, wherein the first hardware configuration and second hardware configuration are for an autonomous vehicle (AV) controller.

There is also disclosed an example of the computing apparatus, wherein the instructions are to run onboard the AV controller.

There is also disclosed an example of the computing apparatus, wherein the instructions are to run on a data center or cloud platform offboard the AV controller.

There is further disclosed an example of one or more non-transitory computer-readable storage media having stored thereon executable instructions to: find an optimum configuration for a set of operational parameters for a second hardware configuration being a modification of a first hardware configuration, based at least in part on a dependency graph for the first hardware configuration and a model of the second hardware configuration, comprising iteratively adjusting a set of operational parameters for the model until a convergence is found; wherein the first and second hardware configurations comprise a plurality of compute nodes with data dependencies on and resource contention with other compute nodes.

There is further disclosed an example of the one or more non-transitory computer-readable storage media, wherein the executable instructions are further to send the optimum configuration to a real-world embodiment of the second hardware configuration.

There is further disclosed an example of the one or more non-transitory computer-readable storage media, wherein the set of operational parameters includes access to shared resources.

There is further disclosed an example of the one or more non-transitory computer-readable storage media, wherein a majority of the plurality of compute nodes are to operate in parallel with one another.

There is further disclosed an example of the one or more non-transitory computer-readable storage media, wherein the plurality of compute nodes comprise a first compute node with a data dependency on a second compute node, wherein the first compute node and second compute node are to operate in parallel with one another.

There is further disclosed an example of the one or more non-transitory computer-readable storage media, wherein the first compute node is to use latest available data from the second compute node.

There is further disclosed an example of the one or more non-transitory computer-readable storage media, wherein the model is a machine learning model.

There is further disclosed an example of the one or more non-transitory computer-readable storage media, wherein the model is a statistical model.

There is further disclosed an example of the one or more non-transitory computer-readable storage media, wherein iteratively modeling the second hardware configuration comprises iteratively modeling until a predicted performance for the second hardware configuration reaches a convergence.

There is further disclosed an example of the one or more non-transitory computer-readable storage media, wherein the optimum configuration is optimum to within a Pareto criterion.

There is further disclosed an example of the one or more non-transitory computer-readable storage media, wherein at least one of the plurality of compute nodes comprises a deep learning (DL) model, and adjusting the set of operational parameters comprises adjusting a number of intermediate layers in the DL model.

There is further disclosed an example of the one or more non-transitory computer-readable storage media, wherein at least one of the plurality of compute nodes comprises a deep learning (DL) model, and adjusting the set of operational parameters comprises adjusting a precision of the DL model.

There is further disclosed an example of the one or more non-transitory computer-readable storage media, wherein the first hardware configuration and second hardware configuration are for an autonomous vehicle (AV) controller.

There is further disclosed an example of the one or more non-transitory computer-readable storage media, wherein the executable instructions are to run onboard the AV controller.

There is further disclosed an example of the one or more non-transitory computer-readable storage media, wherein the executable instructions are to run on a data center or cloud platform offboard the AV controller.

There is also disclosed an example of a method of optimizing an autonomous vehicle (AV) controller after a hardware change, comprising: receiving a first hardware configuration for the AV controller, the first hardware configuration for before the hardware change; receiving a dependency graph for the first hardware configuration; receiving a second hardware configuration for the AV controller, the second hardware configuration for after the hardware change; receiving a model of the second hardware configuration, including a plurality of operational parameters for a plurality of compute nodes having data and resource dependencies according to the dependency graph; and iteratively simulating versions of the model with changes to the operational parameters until a convergence is reached.

There is also disclosed an example of the method, wherein the plurality of operational parameters include access to shared resources.

There is also disclosed an example of the method, wherein a majority of the plurality of compute nodes are to operate in parallel with one another.

There is also disclosed an example of the method, wherein the plurality of compute nodes comprise a first compute node with a data dependency on a second compute node, wherein the first compute node and second compute node are to operate in parallel with one another.

There is also disclosed an example of the method, wherein the first compute node is to use latest available data from the second compute node.

There is also disclosed an example of the method, wherein the model is a machine learning model.

There is also disclosed an example of the method, wherein the model is a statistical model.

There is also disclosed an example of the method, wherein iteratively modeling the second hardware configuration comprises iteratively modeling until a predicted performance for the second hardware configuration reaches a convergence.

There is also disclosed an example of the method, wherein at least one of the plurality of compute nodes comprises a deep learning (DL) model, and adjusting the plurality of operational parameters comprises adjusting a number of intermediate layers in the DL model.

There is also disclosed an example of the method, wherein at least one of the plurality of compute nodes comprises a deep learning (DL) model, and adjusting the plurality of operational parameters comprises adjusting a precision of the DL model.

There is also disclosed an example of the method, wherein the first hardware configuration and second hardware configuration are for an autonomous vehicle (AV) controller.

There is also disclosed an example of an apparatus comprising means for performing the method.

There is also disclosed an example of the apparatus, wherein the means for performing the method comprise a processor and a memory.

There is also disclosed an example of the apparatus, wherein the memory comprises machine-readable instructions that, when executed, cause the apparatus to perform the method.

There is also disclosed an example of the apparatus, wherein the apparatus is a computing system.

There is also disclosed an example of at least one computer-readable medium comprising instructions that, when executed, implement a method or realize an apparatus as described.

Variations and Implementations

As will be appreciated by one skilled in the art, aspects of the present disclosure, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module,” or “system.” In at least some cases, a “circuit” may include both the physical hardware of the circuit, plus any hardware or firmware that programs or configures the circuit. For example, a network circuit may include the physical network interface circuitry, as well as the logic (software and firmware) that provides the functions of a network stack.

Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The foregoing detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The preceding disclosure describes various illustrative embodiments and examples for implementing the features and functionality of the present disclosure. While components, arrangements, and/or features are described below in connection with various example embodiments, these are merely examples used to simplify the present disclosure and are not intended to be limiting.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the description and the claims. Note that all optional features of the apparatus described above may also be implemented with respect to the method or process described herein and specifics in the examples may be used anywhere in one or more embodiments.

The “means for” in these instances (above) can include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

What is claimed is:

1. A computing apparatus, comprising:
a processor circuit and a memory; and
instructions encoded within the memory to instruct the processor circuit to:
receive a stored dependency graph for a first hardware configuration for a plurality of compute nodes;
receive a second hardware configuration comprising a modification to the first hardware configuration;
iteratively model the second hardware configuration comprising adjusting one or more of a plurality of operational parameters for a model of the second hardware configuration, and selecting an optimum configuration of the plurality of operational parameters using the stored dependency graph; and
sending the optimum configuration to a real-world embodiment of the second hardware configuration.

2. The computing apparatus of claim 1, wherein the plurality of operational parameters include access to shared resources.

3. The computing apparatus of claim 1, wherein a majority of the plurality of compute nodes are to operate in parallel with one another.

4. The computing apparatus of claim 1, wherein the plurality of compute nodes comprise a first compute node with a data dependency on a second compute node, wherein the first compute node and second compute node are to operate in parallel with one another.

5. The computing apparatus of claim 4, wherein the first compute node is to use latest available data from the second compute node.

6. The computing apparatus of claim 1, wherein the model is a machine learning model.

7. The computing apparatus of claim 1, wherein the model is a statistical model.

8. The computing apparatus of claim 1, wherein iteratively modeling the second hardware configuration comprises iteratively modeling until a predicted performance for the second hardware configuration reaches a convergence.

9. The computing apparatus of claim 1, wherein the optimum configuration is optimum to within a Pareto criterion.

10. The computing apparatus of claim 1, wherein at least one of the plurality of compute nodes comprises a deep learning (DL) model, and adjusting the plurality of operational parameters comprises adjusting a number of intermediate layers in the DL model.

11. The computing apparatus of claim 1, wherein at least one of the plurality of compute nodes comprises a deep learning (DL) model, and adjusting the plurality of operational parameters comprises adjusting a precision of the DL model.

12. The computing apparatus of claim 1, wherein the first hardware configuration and second hardware configuration are for an autonomous vehicle (AV) controller.

13. The computing apparatus of claim 12, wherein the instructions are to run onboard the AV controller.

14. The computing apparatus of claim 12, wherein the instructions are to run on a data center or cloud platform offboard the AV controller.

15. One or more non-transitory computer-readable storage media having stored thereon executable instructions to:
find an optimum configuration for a set of operational parameters for a second hardware configuration being a modification of a first hardware configuration, based at least in part on a dependency graph for the first hardware configuration and a model of the second hardware configuration, comprising iteratively adjusting a set of operational parameters for the model until a convergence is found;
wherein the first and second hardware configurations comprise a plurality of compute nodes with data dependencies on and resource contention with other compute nodes.

16. The one or more non-transitory computer-readable storage media of claim 15, wherein the executable instructions are further to send the optimum configuration to a real-world embodiment of the second hardware configuration.

17. The one or more non-transitory computer-readable storage media of claim 15, wherein the set of operational parameters includes access to shared resources.

18. A method of optimizing a vehicle controller after a hardware change, comprising:
receiving a first hardware configuration for the vehicle controller, the first hardware configuration for before the hardware change;
receiving a dependency graph for the first hardware configuration;
receiving a second hardware configuration for the vehicle controller, the second hardware configuration for after the hardware change;
receiving a model of the second hardware configuration, including a plurality of operational parameters for a plurality of compute nodes having data and resource dependencies according to the dependency graph; and
iteratively simulating versions of the model with changes to the operational parameters until a convergence is reached.

19. The method of claim 18, wherein the plurality of compute nodes comprise a first compute node with a data dependency on a second compute node, wherein the first compute node and second compute node are to operate in parallel with one another.

20. The method of claim 19, wherein the first compute node is to use latest available data from the second compute node.
